(19) United States
(12) Patent Application Publication
(10) Pub. No.: US 2024/0424811 A1
(43) Pub. Date: Dec. 26, 2024

(54) IMAGE FORMING APPARATUS

(71) Applicant: CANON KABUSHIKI KAISHA, Tokyo (JP)

(72) Inventors: HIROSHI KOKUBO, Tokyo (JP); HIROKI KAJITA, Saitama (JP); AKIHIRO FUJIWARA, Chiba (JP); KOHEI AOKI, Chiba (JP); YUSHI SADAMITSU, Tokyo (JP)

(21) Appl. No.: 18/746,412

(22) Filed: Jun. 18, 2024

(30) Foreign Application Priority Data
Jun. 20, 2023 (JP) 2023-100818
Aug. 29, 2023 (JP) 2023-138904

(51) Int. Cl. B41J 11/00; B41J 2/01; B41J 13/08

(52) U.S. Cl. CPC B41J 11/0022; B41J 2/01; B41J 13/08

(57) ABSTRACT

An image forming apparatus includes a conveyance portion, first, second and third blowing units. The conveyance portion conveys a sheet on which an image is formed by ejecting ink. The first blowing unit blows air onto the sheet conveyed by the conveyance portion. The second blowing unit includes a heater and blows air heated by the heater onto the sheet conveyed by the conveyance portion. The third blowing unit is disposed between the first blowing unit and the second blowing unit with respect to a sheet conveyance direction. The third blowing unit includes a suction portion sucking a part of the air of the conveyance portion, a duct portion through which the air sucked by the suction portion flows and a blowing portion blows the air flowing through the duct portion onto the sheet.

### FIELD OF THE INVENTION AND RELATED ART

The present invention relates to an image forming apparatus for forming an image on a sheet with ink.

In an image forming apparatus in which an image is formed with ink, there is a process for drying a sheet and a process for blowing air onto a sheet. For example, in Japanese Laid-Open Patent Application 2018-202870, a drying device in which a sheet is conveyed by a belt and which dries the sheet by blowing warm air onto the sheet.

### SUMMARY OF THE INVENTION

It is an object of the present invention to provide an image forming apparatus comprising: a conveyance portion configured to convey a sheet on which an image is formed by an image forming portion which forms the image on the sheet by ejecting ink; a first blowing unit configured to blow air onto the sheet conveyed by the conveyance portion; a second blowing unit including a heating means and configured to blow air heated by the heating means onto the sheet conveyed by the conveyance portion; and a third blowing unit disposed between the first blowing unit and the second blowing unit with respect to a sheet conveyance direction, and including a suction portion configured to suck a part of the air of the conveyance portion, a duct portion through which the air sucked by the suction portion flows and a blowing portion configured to blow the air flowing through the duct portion onto the sheet.

Further features of the present invention will become apparent from the following description of exemplary embodiments with reference to the attached drawings.

### BRIEF DESCRIPTION OF THE DRAWINGS

FIG. 1 is a sectional view of a schematic configuration sectional showing an inkjet recording system according to a first embodiment.

FIG. 2 is a sectional view of a schematic configuration showing a drying module, a printing module and a fixing module according to the first embodiment.

FIG. 3 is a sectional view of a schematic configuration showing a warm air blowing unit according to the first embodiment when it is viewed from a side surface.

FIG. 4 is a sectional view of a schematic configuration showing a cold air blowing unit according to the first embodiment when it is viewed from a side surface.

FIG. 5 is a sectional view of a schematic configuration showing a circulating air blowing unit according to the first embodiment when it is viewed from a side surface.

FIG. 6 is a schematic perspective view showing a lower portion of an air blowing duct of the circulating air blowing unit according to the first embodiment.

Part (a) of FIG. 7 is a sectional view of a schematic configuration showing the warm air blowing unit and the cold air blowing unit with regard to a reference example in a case that warm air flows into the cold air blowing unit, and Part (b) of FIG. 7 is a sectional view of a schematic configuration showing the warm air blowing unit and the cold air blowing unit with regard to the reference example in a case that cold air flows into the warm air blowing unit.

FIG. 8 is a schematic front view showing the cold air blowing unit, the circulating air blowing unit and the warm air blowing unit according to the first embodiment.

FIG. 9 is a sectional view of a schematic configuration showing a drying module and a cooling module according to a second embodiment.

FIG. 10 is a sectional view of a schematic configuration showing a warm air blowing unit and a cooling portion according to the second embodiment.

FIG. 11 is a sectional view of a schematic configuration showing a drying belt unit and a cooling portion according to a third embodiment.

FIG. 12 is a sectional view of a schematic configuration showing a warm air blowing unit and a cooling belt unit according to a fourth embodiment.

### DESCRIPTION OF THE EMBODIMENTS

### First Embodiment

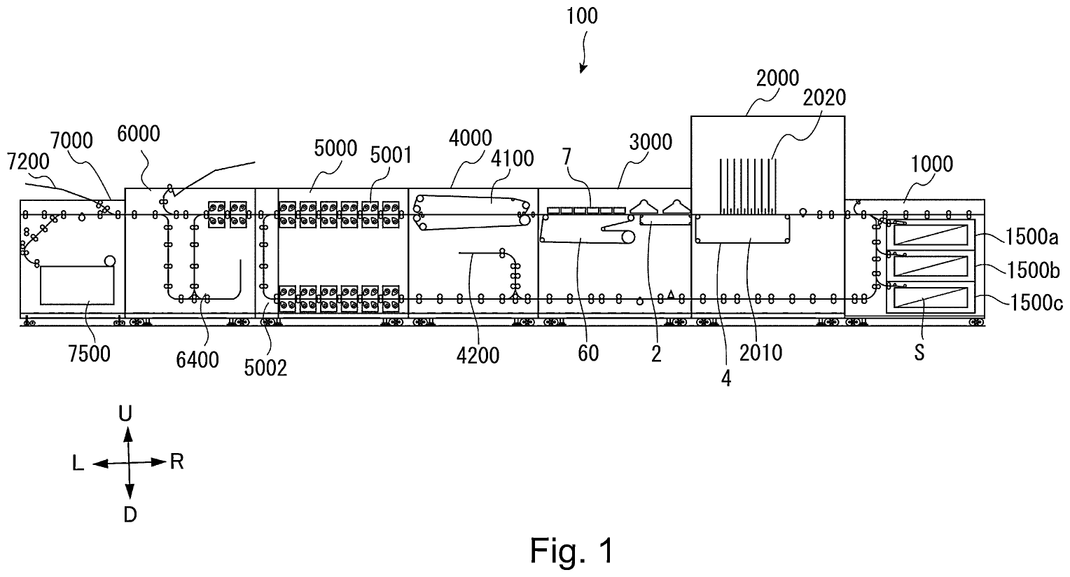

In the following, a first embodiment of the present invention will be specifically described with reference to from FIG. 1 through FIG. 9. In the embodiment, a case of applying an inkjet recording system 100 as an example of an image forming apparatus will be described. First of all, a schematic configuration of the inkjet recording system 100 according to the embodiment will be described by using FIG. 1.

### [Inkjet Recording System]

The inkjet recording system 100 according to the embodiment applies an inkjet recording method which forms an image on a sheet by ejecting ink, and is a so-called sheet-fed type inkjet recording apparatus which forms an ink image on the sheet by using two liquids, reaction liquid and ink. The sheet may be any recording material as far as ink is acceptable, for example, paper such as plain paper and cardboard, plastic film such as an overhead projector sheet, a specially shaped sheet such as an envelope and an index sheet, cloth, etc.

As shown in FIG. 1, the inkjet recording system 100 according to the embodiment is provided with a feeding module 1000, a printing module 2000 and a drying module 3000. Furthermore, the inkjet recording system 100 is provided with a fixing module 4000, a cooling module 5000, a reversing module 6000, and a stacking module 7000. A sheet S which is supplied from the feeding module 1000 is processed in various steps while it is conveyed through each module along a conveying passage, and is finally discharged to the stacking module 7000.

Incidentally, each of the modules from the feeding module 1000 through the stacking module 7000 may include a casing separately, and the inkjet recording system 100 may be configured by connecting these casings. Alternatively, the feeding module 1000, the printing module 2000, the drying module 3000, the fixing module 4000, the cooling module 5000, the reversing module 6000, and the stacking module 7000 may be disposed in one casing.

The feeding module 1000 includes accommodating containers 1500a, 1500b, and 1500c which accommodate the sheet S, and the accommodating containers from 1500a through 1500c are provided so that it is possible to be pulled out toward a front surface side of the apparatus. The sheet S is fed one sheet by one sheet by a separating belt and a conveying roller in each of the accommodating containers from 1500a through 1500c, and conveyed to the printing module 2000. Incidentally, the accommodating containers from 1500a through 1500c are not limited to be three, however, it may include one, two or four or more.

The printing module 2000 as an image forming portion includes a pre image forming registration correction portion (not shown), a print belt unit 2010 and a recording portion 2020. The sheet S which is conveyed from the feeding module 1000 is conveyed to the print belt unit 2010 after its inclination and position are corrected by the pre image forming registration correction portion. With respect to the conveying passage, the recording portion 2020 is disposed at a position opposing the print belt unit 2010. The recording portion 2020 is an inkjet recording portion which forms an image by ejecting ink onto the sheet S with a recording head from above onto the sheet S which is being conveyed. A plurality of recording heads which eject ink are arranged in a line along the conveying direction. In the embodiment, a total of five line type recording heads which corresponds to the reaction liquid in addition to four colors Y (yellow), M (magenta), C (cyan) and Bk (black) are included. Since the sheet S is attracted and conveyed by the print belt unit 2010, clearance with the recording head is ensured.

Incidentally, the number of colors of ink and the number of recording heads are not limited to five which is described above. For an inkjet system, a system which uses a heat generating element, a system which uses a piezoelectric element, a system which uses an electrostatic element, and a system which uses a MEMS (Micro Electro Mechanical Systems) element, etc. may be applied. Ink of each color is supplied from an ink tank (unshown) to the recording head through ink tube, respectively. The ink includes “from 0.1 mass % to 20.0 mass %” based on a total ink mass of resin component, water and water soluble organic solvent, color material, wax, additives, etc.

The sheet S on which an image is formed by the recording portion 2020 is detected by an inline scanner (not shown) which is disposed on a downstream side of the recording portion 2020 with respect to the conveying direction of the sheet S, when the sheet S is conveyed by the print belt unit 2010. At this time, misalignment and color density of the image which is formed on the sheet S are detected, and the image which is formed on the sheet S, the density, etc. are corrected, based on the misalignment and the color density of the image.

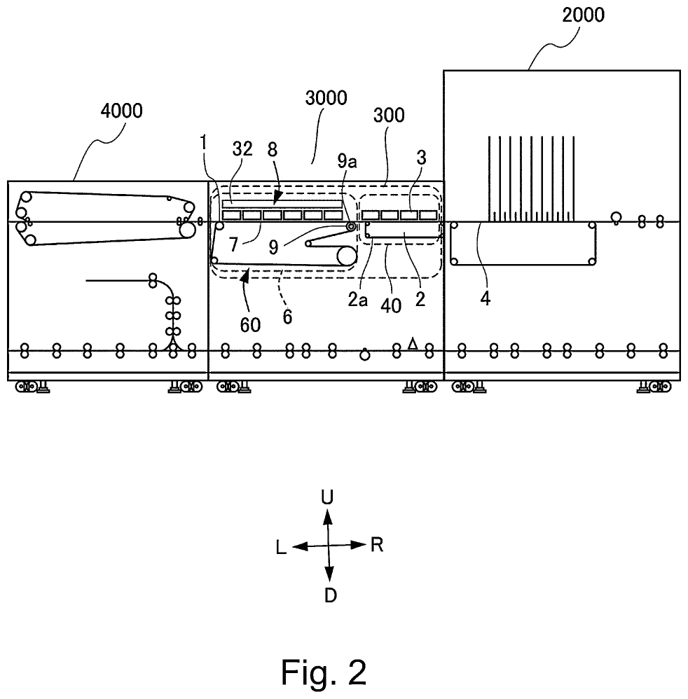

The drying module 3000 is one of examples of a drying device, which dries the sheet S by blowing warm air against the sheet S on which an image is formed. As shown in FIG. 2, the drying module 3000 includes a decoupling portion 40, a drying belt unit 60 and a warm air blowing unit 8. The drying module 3000 reduces liquid content of the ink and the reaction liquid which are applied to the sheet S in order to improve fixation property of the ink on the sheet S by the subsequent fixing module 4000. The sheet S on which the image is formed is conveyed to the decoupling portion 40 which is disposed in the drying module 3000. In the decoupling portion 40, frictional force is generated between the sheet S and a belt by wind pressure which is blown from above and the sheet S is conveyed by the belt. In this way, since the sheet S which is placed on the belt is conveyed by the frictional force, misalignment of the sheet S when it is conveyed across the print belt unit 2010 and the decoupling portion 40 is prevented. The sheet S which is conveyed from the decoupling portion 40 is attracted and conveyed by the drying belt unit 60, and the ink and the reaction liquid which are applied to the sheet S are dried when warm air is blown from the warm air blowing unit 8 which is disposed above the belt.

In this way, since the ink and the reaction liquid which are applied to the sheet S is heated by the drying module 3000 and evaporation of the moisture is promoted, it is possible to suppress generating so-called cockling which forms lines around the ink like fringe when the ink splashes onto the sheet S. Incidentally, as for a heater which heats air, for example, an electric heating wire or an infrared heater, is preferable in terms of safety and energy efficiency. Further, in addition to a method of providing hot air, a drying method may be configured by combining irradiating electromagnetic waves (ultraviolet rays, infrared rays, etc.) to the surface of the sheet S, or a conductive heat transfer method by contacting a heating member.

As shown in FIG. 1, the fixing module 4000 as a fixing system includes a fixing belt unit 4100. The fixing belt unit 4100 fixes the ink on the sheet S by passing through the sheet S, which has been conveyed from the drying module 3000, between an upper belt unit and a lower belt unit which are heated.

The cooling module 5000 includes a plurality of cooling portions 5001, and the sheet S at high temperature which is conveyed from the fixing module 4000 is cooled by the cooling portions 5001. The cooling portions 5001 cool the sheet S, for example, by increasing pressure in the cooling box when taking outside air into a cooling box with a fan and applying air which is blown from the cooling box through nozzles due to the pressure to the sheet S. The cooling portions 5001 are disposed on both sides of the conveying passage of the sheet S and cool both sides of the sheet S.

The cooling module 5000 is provided with a conveying passage switching portion 5002. The conveying passage switching portion 5002 switches conveying passages of the sheet S according to a case that the sheet S is conveyed to the reversing module 6000 or a case that the sheet S is conveyed to a duplex (double-side) conveying passage for duplex printing in which image forming is performed on both sides of the sheet S.

The reversing module 6000 includes a reversing portion 6400. The reversing portion 6400 reverses front and back of the sheet S which is being conveyed and changes a front and back direction of the sheet S when it is discharged to the stacking module 7000. The stacking module 7000 includes a top tray 7200 and a stacking portion 7500, and stacks the sheets S which is conveyed from the reversing module 6000.

During duplex printing, the sheet S is conveyed to the conveying passage below the cooling module 5000 by the conveying passage switching portion 5002. After that, the sheet S is returned to the printing module 2000 through the duplex conveying passage of the fixing module 4000, the drying module 3000, the printing module 2000 and the feeding module 1000. A duplex conveyance portion of the fixing module 4000 is provided with a reversing portion 4200 which reverses front and back of the sheet S. After the sheet S has been returned to the printing module 2000, an image is formed on the other surface of the sheet S on which the image is not formed, and the sheet S is discharged to the stacking module 7000 from the drying module 3000 via the reversing module 6000.

### [Drying Module]

Next, the drying module 3000 will be described in detail by using from FIG. 2 through FIG. 9. FIG. 2 is a schematic view showing a state that the printing module 2000, the drying module 3000 and the fixing module 4000 are connected. Incidentally, in each figure, a front side of the inkjet recording system 100 is marked as F for a forward direction, a back surface side is marked as B for a backward direction, a right side toward is marked as R for a right direction, a left side toward is marked as L for a left direction, an upper side is marked as U for an upward direction and a lower side is marked as D for a downward direction.

As shown in FIG. 2, the drying module 3000 includes the decoupling portion 40, the drying belt unit 60 and the warm air blowing unit 8. These are collectively referred to as a drying function portion 300. The drying function portion 300 is disposed in an upper part of the drying module 3000 and includes a straight sheet conveying passage 1 to receive the sheet S which is discharged from the printing module 2000, dry the sheet S and then deliver the sheet S to the fixing module 4000. With respect to a sheet conveying direction (the left direction L in FIG. 2) in the sheet conveying passage 1, functions are different between an upstream portion and a downstream portion of the drying function portion 300.

In the upstream portion of the drying function portion 300, the decoupling portion 40 is disposed. The decoupling portion 40 includes a decoupling belt unit 2 and a cold air blowing unit 3. The cold air blowing unit 3 is disposed above the decoupling belt unit 2 in a vertical direction, and the decoupling belt unit 2 conveys the sheet S in a substantially horizontal direction. That is, the decoupling belt unit 2 is one of examples of a second conveyance portion, disposed adjacent to the drying belt unit 60 with respect to the sheet conveying direction and conveys the sheet S on which an image is formed in the printing module 2000. Further, the cold air blowing unit 3 is one of examples of a first air blowing unit and blows air onto the sheet S which is conveyed by the decoupling belt unit 2.

The cold air blowing units 3 are disposed adjacent to each other along the sheet conveying direction. The decoupling belt unit 2 includes an endless belt 2a which is rotatable. And the sheet S is conveyed while the sheet S is pressed toward the belt 2a by blowing cold air (air) from an upper side of the decoupling belt unit 2 by the cold air blowing unit 3. The decoupling belt unit 2 is provided with a plurality of holes for passing air which is blown from the cold air blowing unit 3 from a blowing surface to a belt opposing side. Incidentally, air which has not been heated by a heater, such as outside air of a main assembly, is also referred to as “cold air” in the following.

When a leading end of the sheet S reaches the decoupling belt unit 2 of the drying module 3000, a trailing end of the sheet S is still on the print belt unit 2010 of the printing module 2000. The print belt unit 2010 includes an endless print belt 4 which sucks and conveys the sheet S. On the print belt 4, image forming is performed on the sheet S, and the sheet S is sucked and conveyed on the print belt 4. To avoid any disturbance to the image forming process, force which presses the sheet S against the belt 2a is weaker than force which sucks the print belt 4, and the belt 2a is driven at a slightly faster speed than the print belt 4. That is, the sheet S always slides on the belt 2a while the trailing end of the sheet S is on the print belt 4.

On the other hand, as soon as the trailing end of the sheet S leaves a region of the print belt 4, conveyance of the sheet S becomes dependent on the belt 2a. At this time, it is necessary to control air blowing force of the cold air blowing unit 3 so that the sheet S does not slide against conveyance resistance. So, velocity of air which is blown from the cold air blowing unit 3 onto the sheet S which is conveyed on the belt 2a is controlled to a predetermined pressure by using a pressure sensor (not shown) which is provided inside the cold air blowing unit 3 and a suction fan (not shown) which is provided with an air suction portion. The cold air blowing unit 3 includes a blowing surface with which a number of blowing holes 5 for air to pass through are provided so that it is possible to apply uniform pressing force to the sheet S.

### [Drying Portion]

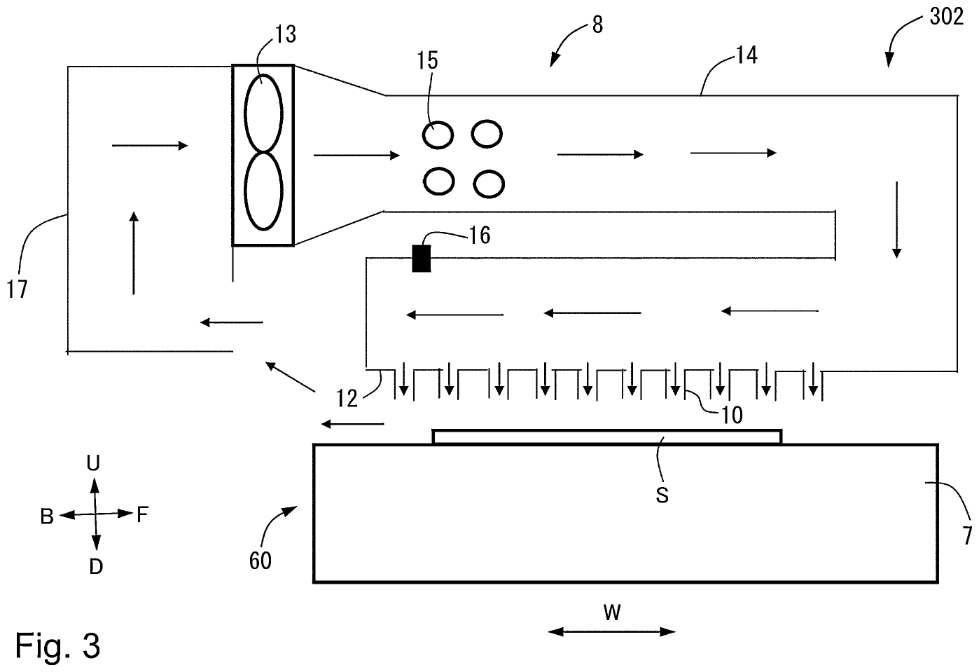

Next, a drying portion 6 will be described by using FIG. 2 and FIG. 3. In the downstream portion of the drying function portion 300, the drying portion 6 is disposed. The drying portion 6 includes the drying belt unit 60 and the warm air blowing unit 7. The warm air blowing unit 8 is disposed above the drying belt unit 60 in the vertical direction, and is disposed adjacent to each other along the sheet conveying direction. The drying belt unit 60 is one of examples of a first conveyance portion and conveys the sheet S on which an image is formed in the printing module 2000.

### [Warm Air Blowing Unit]

Next, the warm air blowing unit 8 will be described by using FIG. 3. Arrows which are shown in FIG. 3 indicate air flow. The warm air blowing unit 8 includes an air blowing fan 13, an air blowing duct 14, a heater 15, a temperature sensor 16, a suction duct 17, etc. In the embodiment, the air blowing fan 13 is an axial flow fan. However, it is not limited to an axial flow fan, but other air blowing sources such as a sirocco fan may be used. The heater 15 is a sheathed heater. However, it is not limited to a sheathed heater, but other heat sources such as a Kanthal heater may be used. The suction duct 17 is connected to the air blowing fan 13 on its suction side. The warm air blowing unit 8 is one of examples of a second air blowing unit and blows air which is heated by the heater 15 onto the sheet S which is conveyed by the drying belt unit 60. Further, the warm air blowing unit 8 is one of examples of a drying unit and dries the sheet S on which an image is formed.

The air blowing duct 14 is provided with the heater 15 and the temperature sensor 16 inside, and the air blowing fan 13 on its discharging side is connected to the air blowing duct 14 on its end portion. That is, the air blowing fan 13 is provided on an upstream end portion of the air blowing duct 14. The heater 15 is disposed on a downstream side of an air blowing passage of the air blowing fan 13. The heater 15 is one of examples of a heating means, is provided downstream from the air blowing fan 13 in the air blowing duct 14 and heats the air which blows through the air blowing duct 14.

A surface opposing the sheet S further downstream of the heater 15 is a blowing surface 12, and a plurality of blowing nozzles 10 are formed. The temperature sensor 16 is mounted on an upper surface opposing the blowing nozzles 10 in the air blowing duct 14. Electric current which heats the heater 15 is controlled by a control portion (not shown), according to temperature which is detected by the temperature sensor 16. Here, air velocity of airflow at an outlet of the blowing nozzle 10 is approximately from 30 m/s to 40 m/s and temperature of the warm air is from 70° C. to 90° C. Further, the distance between the blowing surface 12 and the sheet S is from 10 mm to 12 mm.

### [Drying Belt Unit]

Next, the drying belt unit 60 will be described by using FIG. 2. The drying belt unit 60 includes a drying belt 7 which is a rotatable and endless conveying belt, a plurality of stretching rollers 9 which stretch the drying belt 7, and a belt heater 9a which heats the drying belt 7, and conveys a sheet while heating the sheet with the drying belt 7. The belt heater 9a is a halogen heater which is disposed inside any stretching roller 9 of the plurality of stretching rollers 9 and heats the drying belt 7 via the stretching roller 9. In the embodiment, among pairs of stretching rollers 9 which stretch a surface opposing the warm air blowing unit 8, the belt heater 9a is disposed inside the stretching roller 9 on an upstream side with respect to the sheet conveying direction.

Furthermore, the drying belt unit 60 includes a suction box (not shown) which is disposed on an inner peripheral side of the drying belt 7 and a suction fan (not shown) which is connected to the suction box. The drying belt 7 includes a plurality of suction holes through which air is sucked by the suction fan. A suction opening is formed on a surface of the suction box opposing the drying belt 7. And a configuration is such that the sheet S is attracted to the surface of the drying belt 7, when the suction fan sucks air through the suction box and air is sucked through the plurality of suction holes of the drying belt 7.

In the drying portion 6, while the sheet S is attracted onto the drying belt 7 by sucking the sheet S with the drying belt unit 60, the sheet S is dried when warm air is blown from an upper side in the vertical direction by the warm air blowing unit 8, and the sheet S is conveyed while suppressing waving which is called cockling. In order to dry the sheet S rapidly, surface temperature of the drying belt 7 is adjusted to a predetermined temperature by controlling the belt heater 9a which is disposed inside the stretching roller 9 based on temperature which is detected by a temperature sensor (not shown) which is provided inside the drying belt unit 60. In this way, the sheet S which is conveyed by the drying belt 7 is heated.

On the other hand, a warm air temperature inside the warm air blowing unit 8 is controlled at a predetermined temperature by using the temperature sensor 16 and the heater 15 which are provided inside the unit. Further, velocity of air which is blown from the warm air blowing nozzles 10 of the warm air blowing unit 8 is controlled to a predetermined pressure by using a pressure sensor (not shown) which is provided inside the unit and the suction fan. The warm air blowing unit 8 dries the ink on the sheet S by such a configuration.

In order to fix the sheet S on the drying belt 7, a suction pressure on a top surface of the drying belt 7 is adjusted to a predetermined pressure by controlling the suction fan based on pressure which is detected by a pressure sensor (not shown) which is provided inside the suction box. In this way, the warm air blowing unit 8 presses the sheet S onto the drying belt 7 by blowing warm air. Incidentally, a distance from a suction end position of the print belt 4 to a suction start position of the drying belt 7 is set to be longer than a maximum sheet length. [Cold air blowing unit].

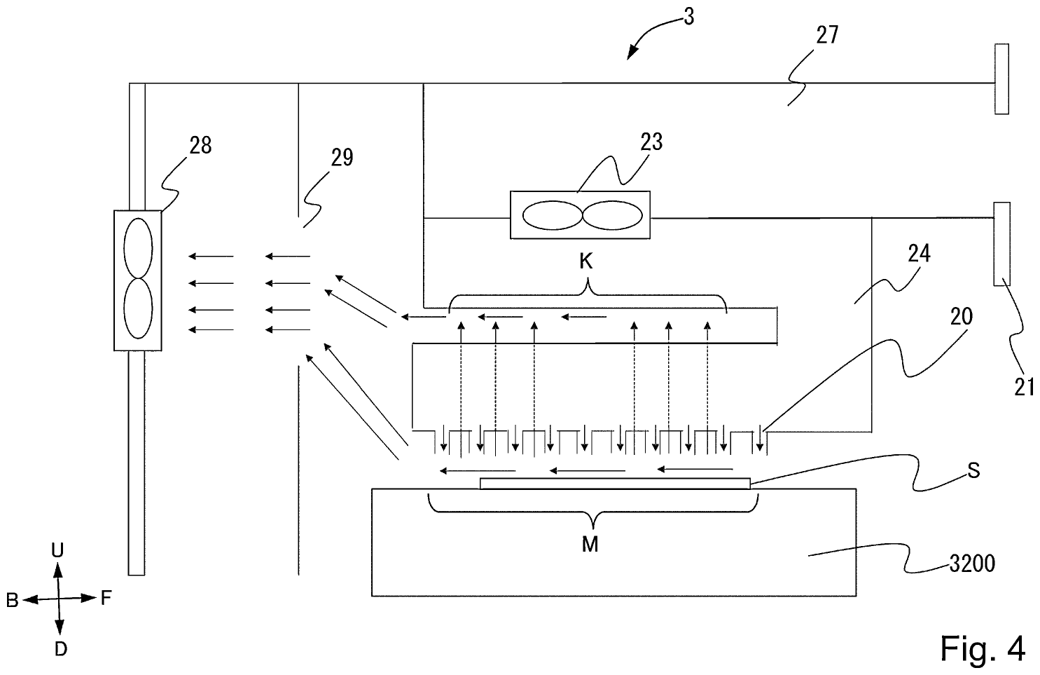

Next, a configuration of the cold air blowing unit 3 according to the embodiment will be described in detail. As shown in FIG. 2, the cold air blowing unit 3 is disposed upstream of the warm air blowing unit 8 with respect to the sheet conveying direction and is disposed opposing an upper portion of the decoupling belt unit 2 which is disposed downstream of the print belt unit 2010 with respect to the sheet conveying direction. As shown in FIG. 4, the cold air blowing unit 3 includes an air blowing fan 23, an air blowing duct 24, a suction duct 27 and a cold air blowing nozzle 20.

In the printing module 2000, a recording process (printing) is performed from the recording portion 2020 (see FIG. 1) toward the sheet S which is positioned below the recording portion 2020 and an image is formed. At this time, most of ink which is released from the recording portion 2020 moves onto the sheet S, however, a phenomenon in which some of ink becomes mist (hereinafter referred to as ink mist) and flies (floats) in the printing module 2000 is caused. When the ink mist reaches the drying module 3000 by airflow, it may gradually accumulate in the heater 15 which is mounted in the drying module 3000. In this case, performance of the heater may be decreased, so it is desirable to replace the heater 15 according to an amount of the ink mist which is accumulated.

Further, when heat which is generated in the drying module 3000 is moved to the recording portion 2020, condensation may occur in the recording portion 2020. When water drop which is produced by dew condensation is adhered to the recording portion 2020, ink which is ejecting and the water drop may be mixed together, fall onto the sheet S, and cause image defect. The dew condensation is caused by temperature difference between a surface of the recording portion 2020 and air around the recording portion 2020. For the recording portion 2020, since temperature of the ink inside is kept at an approximate room temperature, surface temperature of the recording portion 2020 is also kept low in accordance with the temperature of the ink. On the other hand, when hot air in the drying module 3000 moves to the printing module 2000, temperature of air inside the printing module 2000 increases. In that case, the surface temperature of the recording portion 2020 becomes relatively lower than the temperature of the air in the printing module 2000, and dew condensation is caused when a dew point of air is exceeded near the surface of the recording portion 2020. Therefore, in the embodiment, a suction and discharging configuration of the cold air blowing unit 3 is made as follows. The configuration will be described in detail by using FIG. 4. In the cold air blowing unit 3, an air suction is performed from an outside of the main assembly, as described above. The air which is sucked by the air blowing fan 23 through suction holes of an exterior surface 21 is blown onto the sheet S, which is passing, by the cold air blowing nozzle 20. The air which is blown is withdrawn by a discharging fan 28 and discharged outside the main assembly.

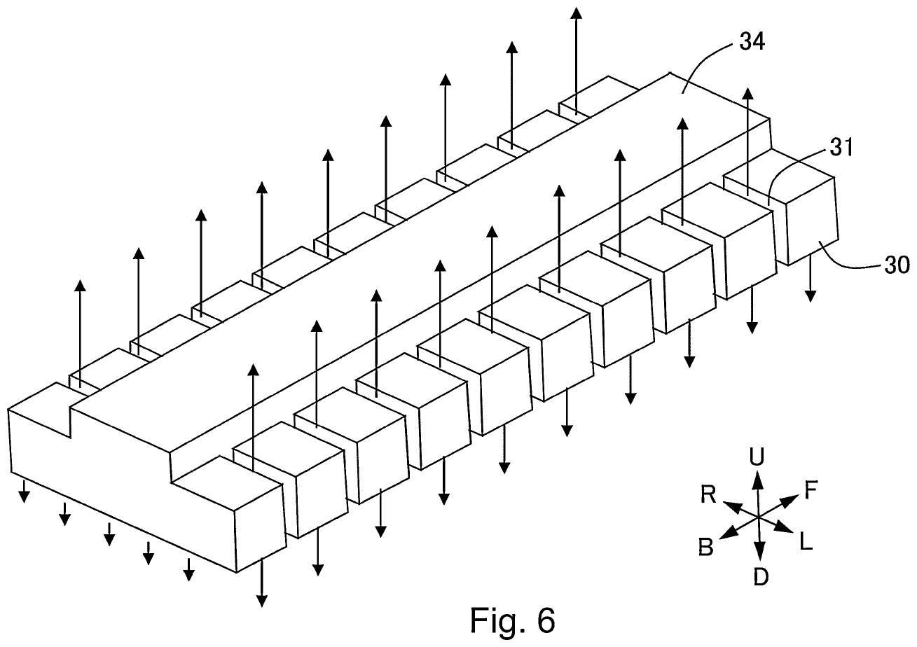

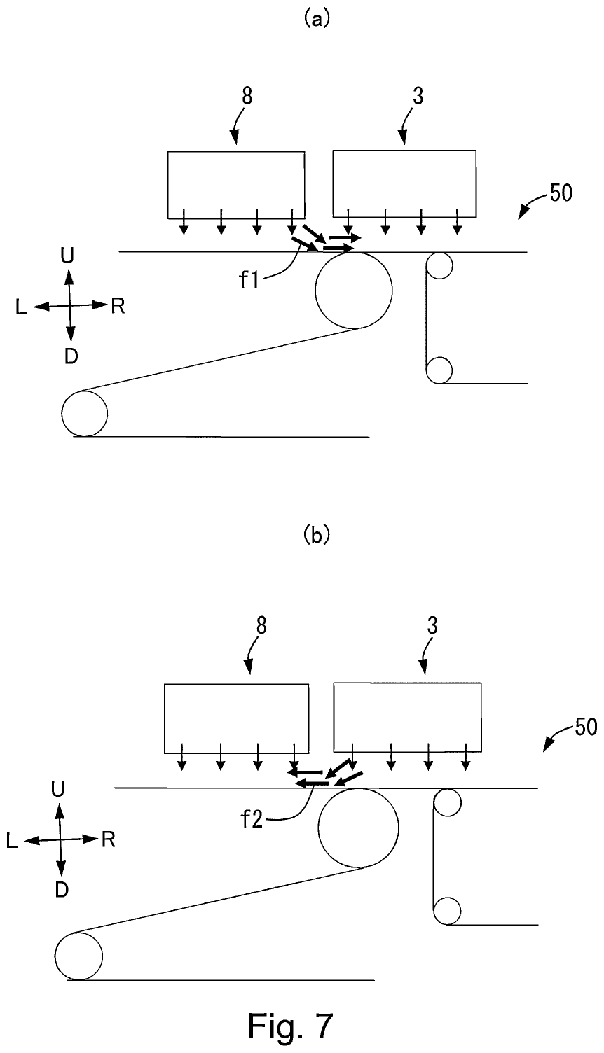

Next a passage of the airflow of the air which is blown onto the sheet S until discharged outside of the main assembly will be described by using FIG. 4. The air blowing duct 24 is provided with a gap between the adjacent cold air blowing nozzles 20. The airflow which is blown onto the sheet S by the cold air blowing nozzle 20 passes through the gap at least partly, and moves above the cold air blowing nozzle 20 (K in FIG. 4). FIG. 6 is a perspective view of the air blowing duct 34 of a circulating air blowing unit 5, and gaps which are similar to gaps 31 of the air blowing duct 34 are also provided with the air blowing duct 24 of the cold air blowing unit 3. The air which is moved above the cold air blowing nozzle 20 is sucked by the discharging fan 28, moves toward a back side of the main assembly and heads for a ventilation opening 29 which is disposed upstream of the airflow path of the discharging fan 28. Further, a part of air (M in FIG. 4) which does not move above the cold air blowing nozzle 20 also moves inside a conveyance passage toward the back side of the main assembly due to pressure difference which is made by the discharging fan 28, and also heads for the ventilation opening 29. Therefore, even when the ink mist which is generated in the printing module 2000 moves to the cold air blowing unit 3 which is downstream with respect to the conveying direction, it moves to the back side of the main assembly following the airflow toward the ventilation opening 29. As a result, it is possible to prevents the ink mist from heading for the warm air blowing unit 8. Incidentally, in the embodiment, a case in which the air blowing duct 24 includes the gaps between the adjacent cold air blowing nozzles 20 is described, however, it is not limited to this and it may not include such gaps. In the case, the airflow which is blown onto the sheet S by the cold air blowing nozzle 20 does not move upward along the air blowing duct 24, but moves towards the back of the main assembly inside the conveyance passage and heads for the ventilation opening 29.

Further, in the embodiment, air volume of the discharging fan 28 is set to be larger compared to air volume of the air blowing fan 23. As a result, the discharging fan 28 is possible to withdraw the air which is blown onto the sheet S by the air blowing fan 23 and it is possible to ensure that the airflow toward the ventilation opening 29 is formed.

In the embodiment, an axial flow fan is applied to the air blowing fan 23, however, other air blowing sources, such as a sirocco fan, may be applied. The suction duct 27 is disposed on a suction side of the air blowing fan 23, and an end portion of the suction duct 27 on a discharging side is connected to the suction side of the air blowing fan 23. Further, the end portion of the suction duct 27 on the suction side is connected to a suction hole 301a in an exterior 301 which is a back side plate of the main assembly, so it is possible to suck air through the suction hole 301a. As a result, when the air blowing fan 23 operates, fresh air from outside of the main assembly is sucked to the air blowing fan 23. That is, the cold air blowing unit 3 includes the suction duct 27 which sucks air from outside of the main assembly of the inkjet recording system 100 and blows air which is sucked from the suction duct 27 onto the sheet S which is conveyed by the decoupling belt unit 2.

Further, the air blowing duct 24 is connected to a discharging side of the air blowing fan 23, and an end portion of the air blowing duct 24 on a discharging side is connected to the air blowing fan 23. On the other hand, at an end portion of the air blowing duct 24 on a discharging side, the cold air blowing nozzle 20 is provided on a surface opposing the sheet S. The airflow which is generated by the air blowing fan 23 is blown onto the sheet S, which is being conveyed, through the cold air blowing nozzle 20. The decoupling belt unit 2 is provided opposing the cold air blowing nozzle 20 in a downward direction D. The sheet S is pressed against the decoupling belt unit 2 by the wind pressure of the airflow which is blown from the cold air blowing nozzle 20. As described above, the cold air blowing unit 3 sucks air from outside of the main assembly. Unlike the warm air blowing unit 8, the cold air blowing unit 3 is possible to blow air at the same temperature as the outside temperature (lower temperature than the warm air blowing unit 8) onto the sheet S. Depending on the outside temperature, the air velocity of the airflow which is blown from the cold air blowing unit 3 is from 30 m/s to 40 m/s and the temperature of the airflow is from 20° C. to 40° C.

### [Circulating Air Blowing Unit]

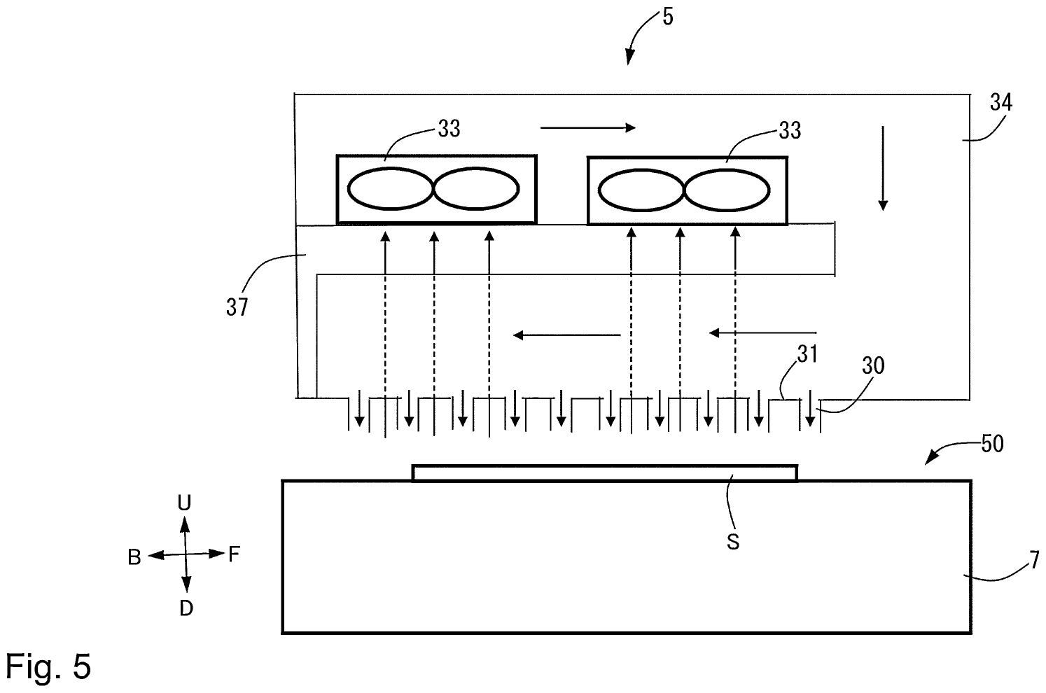

Next, a configuration of the circulating air blowing unit 5 according to the embodiment will be described in detail by using FIG. 5 and FIG. 6. The circulating air blowing unit 5 is one of examples of a third air blowing unit and is disposed between the warm air blowing unit 8 and the cold air blowing unit 3 with respect to the sheet conveying direction. That is, the circulating air blowing unit 5 is disposed adjacent to and upstream of the warm air blowing unit 8 with respect to the sheet conveying direction. The circulating air blowing unit 5 according to the embodiment includes an air blowing fan 33, the air blowing duct 34, a suction duct 37 and a blowing nozzle 30. An axial flow fan is applied to the air blowing fan 33 in the embodiment, however, other air blowing sources, such as a sirocco fan, may be applied.

The suction duct 37 is connected to a suction side of the air blowing fan 33. An end portion of the blowing duct 34 on a suction side is connected to a discharging side of the air blowing fan 33. On the other hand, at an end portion of the air blowing duct 34 on a discharging side, a plurality of blowing nozzles are provided on a surface opposing the sheet S. In the embodiment, the air blowing duct 34 is formed to be a substantially U-shape as a whole in a horizontal when it is viewed from the sheet conveying direction, the air blowing fan 33 is connected in an upper portion of the air blowing duct 34 which is a suction side, and the blowing nozzle 30 is formed in a lower portion of the air blowing duct 34 which is a discharging side. The airflow which is generated by the air blowing fan 33 is blown onto the sheet S, which is being conveyed, through the blowing nozzle 30.

As shown in FIG. 5 and FIG. 6, in the circulating air blowing unit 5 according to the embodiment, the gaps 31 are provided between the blowing nozzles 30. Wall portions which divide the gaps 31 substantially form a part of the suction duct 37. The airflow which is blown onto the sheet S by the blowing nozzle 30 is configured so that at least a part of the air moves substantially upward in the vertical direction through the gap 31, circulates through the suction duct 37 and is sucked by the air blowing fan 33.

The suction duct 37 is one of examples of a suction portion and sucks a part of the air which is blown from the warm air blowing unit 8 and a part of the air which is blown from the cold air blowing unit 3 through the gap 31. The air blowing duct 34 is one of examples of a duct portion, through which the air which is sucked by the suction duct 37 flows. The air which is sucked by the suction duct 37 is stirred by passing through the air blowing duct 34 and the temperature is almost uniform. The blowing nozzle 30 is one of examples of a blowing portion and blows the air which is flowed through the air blowing duct 34 onto the sheet S which is conveyed between the drying belt unit 60 and the decoupling belt unit 2. The circulating air blowing unit 5 is disposed above the drying belt unit 60 and the decoupling belt unit 2 in the vertical direction and the suction duct 37 sucks air upward in the vertical direction and the blowing nozzle 30 blows air downward in the vertical direction.

Incidentally, the circulating air blowing unit 5 is different from the warm air blowing unit 8 in that a heater is not disposed in its air path. By not disposing a heater, the air which is blown from the circulating air blowing unit 5 is not as hot as in the warm air blowing unit 8. Further, in the embodiment, the air velocity of the airflow which is blown from the circulating air blowing unit 5 is from 30 m/s to 40 m/s and the temperature of the airflow is from 40° C. to 60° C.

As shown in FIG. 5, an air flow configuration of the circulating air blowing unit 5 is a self-circulation type, in which at least a part of the air which is blown toward the conveyance passage by the air blowing fan 33 is sucked from the suction duct 37 and is blown toward the conveyance passage from the air blowing fan 33 again. Furthermore, a filter is provided in the circulating air blowing unit 5, which is configured that the mist in the airflow is collected by the suction duct 37. Therefore, it is possible to more reliably block the ink mist which is generated in the printing module 2000 from heading for the warm air blowing unit 8 by the circulating air blowing unit 5. Incidentally, the circulating air blowing unit 5 is not provided with a heat source such as a heater in its air path. Therefore, the air which comes out of the air blowing fan 33 in the circulating air blowing unit 5 is not warm air as in the warm air blowing unit 8, nor is it outside air (cold air) as in the cold air blowing unit 3. Thus, it is possible to minimize changes in temperature of the air of the cold air blowing unit 3 and temperature of the air of the warm air blowing unit 8, without extremely changing temperature of the air (cold air) which comes from the cold air blowing unit 3 and the air (warm air) which comes from the warm air blowing unit 8.

### Issue to be Solved in the Embodiment

Here an issue to be solved in the embodiment will be described by using reference examples which are shown in part (a) and part (b) of FIG. 7. It is known that when the warm air which comes from the warm air blowing unit 8 flows into a conveyance passage 50 which is upstream with respect to the sheet conveying direction, waving (cockling) of the sheet S is deteriorated. This mechanism will be described below. A case in which warm air is applied to the sheet S, before a drying process in the warm air blowing unit 8 is performed to the sheet S on which ink has been printed, will be described. In the case, due to decreasing viscosity of a liquid component in the ink which is printed on the sheet S, the liquid component in the ink becomes easier to penetrate into the sheet S (it becomes smooth and soaks in as it warms up). Therefore, the liquid component in the ink may excessively permeate into the sheet S before the drying process is performed in the warm air blowing unit 8. When the liquid component in the ink permeates the sheet S, paper fibers of the sheet S expand in an area in which penetration is occurred in the sheet S. On the other hand, paper fibers of the sheet S do not expand in area in which ink printing is not performed. Thus, the expanded area and the non-expanded area of the paper fibers of the sheet S are mixed in the sheet S, and cockling may occur in the sheet S due to differences in amount of expansion.

In order to solve this, it is necessary to suppress the penetration of the liquid component by applying cold air with the cold air blowing unit 3 according to the embodiment. In the embodiment, it is configured to blow the air which is the same temperature (cold air) as room temperature by performing suction of the cold air blowing unit 3 from outside of the main assembly. However, as shown in part (a) of FIG. 7, when the cold air blowing unit 3 is disposed directly upstream of the warm air blowing unit 8, a part of the warm air which is blown from the warm air blowing unit 8 may generate an airflow f1 which flows upstream in the sheet conveying direction through the conveyance passage. In this way, an adverse effect on cockling may be occurred by increasing the temperature of the cold air in the cold air blowing unit 3.

On the other hand, as shown in part (b) of FIG. 7, when the air which is blown from the cold air blowing unit 3 becomes an airflow f2 and flows downstream in the sheet conveying direction into a region of the warm air blowing unit 8, the temperature of the warm air which is blown from the warm air blowing unit 8 may decrease. In this way, insufficient drying of the sheet S may be occurred because it does not obtain necessary heat energy for drying. Alternatively, power consumption of the warm air blowing unit 8 may be increased because it is necessary to increase temperature of the heater 15 in order to ensure heat energy which is necessary for drying.

### Effect in the Embodiment

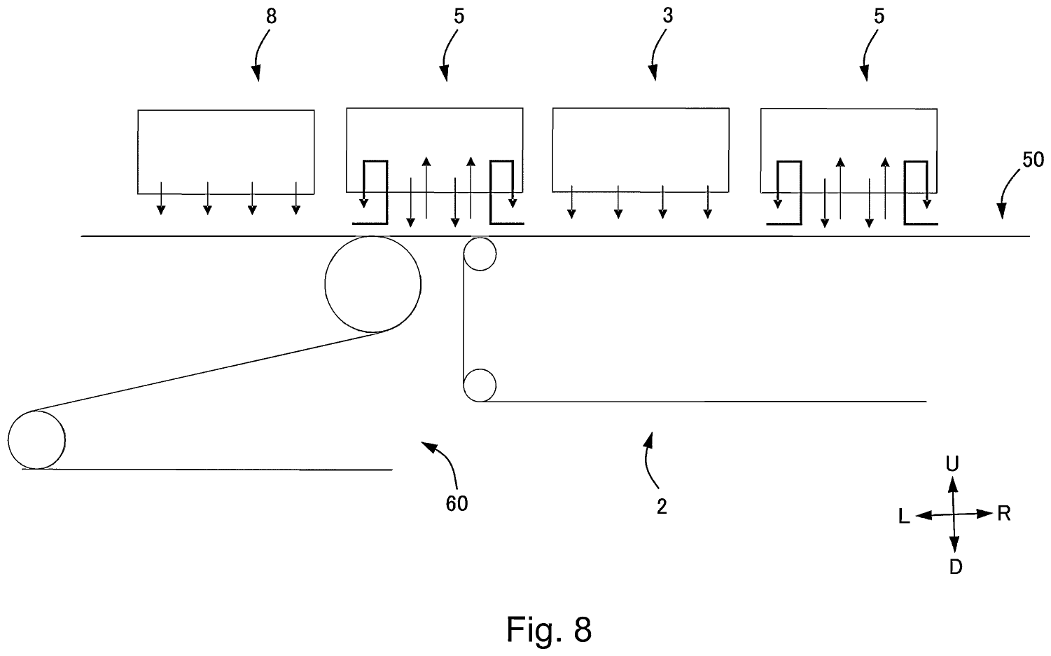

For this reason, in the embodiment, as shown in FIG. 8, the circulating air blowing unit 5, which is one of examples of the third air blowing unit, is disposed between the warm air blowing unit 8 which is one of examples of the second air blowing unit and the cold air blowing unit 3 which is one of examples of the first air blowing unit. Therefore, it is possible to prevent the air (cold air) which is blown from the cold air blowing unit 3 which is located on an upstream side of the circulating air blowing unit 5 and the air (warm air) which is blown from the warm air blowing unit 8 from contacting directly. As a result, it is possible to prevent the air which is blown from the warm air blowing unit 8 from entering into a region of the cold air blowing unit 3 and, conversely, it is possible to prevent the air which is blown from the cold air blowing unit 3 from entering into a region of the warm air blowing unit 8.

Further, the air flow configuration of the circulating air blowing unit 5 is the self-circulation type, in which at least a part of the air which is blown toward the conveyance passage 50 by the air blowing fan 33 is sucked from the suction duct 37 and is blown toward the conveyance passage 50 from the air blowing fan 33 again. Further, a heat source such as a heater is not provided in its air path. Therefore, the air which comes out of the air blowing fan 33 in the circulating air blowing unit 5 is not warm air as in the warm air blowing unit 8, nor is it outside air (cold air) as in the cold air blowing unit 3.

Thus, the temperature of the air which is blown from the circulating air blowing unit 5 is not significantly different from the temperature of the air (cold air) which comes from the cold air blowing unit 3 and the temperature of the air (warm air) which comes from the warm air blowing unit 8. As a result, even when a part of the air which is blown from the circulating air blowing unit 5 flows into a surrounding area, it is possible to suppress changes in the temperature of the air in the cold air blowing unit 3 and the warm air blowing unit 8, which are disposed adjacent to each other, compared to a case which is shown in FIG. 7.

Further, in the embodiment, the circulating air blowing unit 5 is disposed between the warm air blowing unit 8 and the cold air blowing unit 3, and is also disposed between the cold air blowing unit 3 and the recording portion 2020. Therefore, it is possible to prevent the air (cold air) which is blown from the cold air blowing unit 3 which is located on the upstream side of the circulating air blowing unit 5 and the air (warm air) which is blown from the warm air blowing unit 8 from contacting directly. Further, it is possible to prevent the ink mist in the recording portion 2020 from moving to the warm air blowing unit 8 by providing the plurality of circulating air blowing units 5 between the warm air blowing unit 8 and the recording portion 2020. Incidentally, the cold air blowing unit 3 is one of examples of an air blowing unit, and the circulating air blowing unit 5 is one of examples of an air blowing unit. Further, in the embodiment, a case in which the circulating air blowing unit 5 is disposed between the cold air blowing unit 3 and the recording portion 2020 is described, however it is not limited to this. The circulating air blowing unit 5 may not be disposed between the cold air blowing unit 3 and the recording portion 2020.

As described above, in the inkjet recording system 100 according to the embodiment, the circulating air blowing unit 5 is disposed between the warm air blowing unit 8 and the cold air blowing unit 3. The circulating air blowing unit 5 blows the air which flows through the air blowing duct 34 onto the sheet S which is conveyed between the drying belt unit 60 and the decoupling belt unit 2. And the circulating air blowing unit 5 sucks at least a part of the air which is blown from the suction duct 37 and circulates it to blow it onto the sheet S again. Therefore, it is possible to prevent the air which is blown from the warm air blowing unit 8 from entering into the region of the cold air blowing unit 3 and, conversely, it is possible to prevent the air which is blown from the cold air blowing unit 3 from entering into the region of the warm air blowing unit 8. As a result, it is possible to suppress diffusion of the warm air in the main assembly which is blown inside the main assembly of the inkjet recording system 100 while drying the sheet S by the warm air, so it is possible to suppress an occurrence of cockling, etc.

Incidentally, in the embodiment, a configuration of the image forming system for sheet paper printing as shown in FIG. 1 is described. However, the image forming system is not limited to a sheet paper printing machine, but it is also possible to apply to a continuous printing machine.

### Second Embodiment

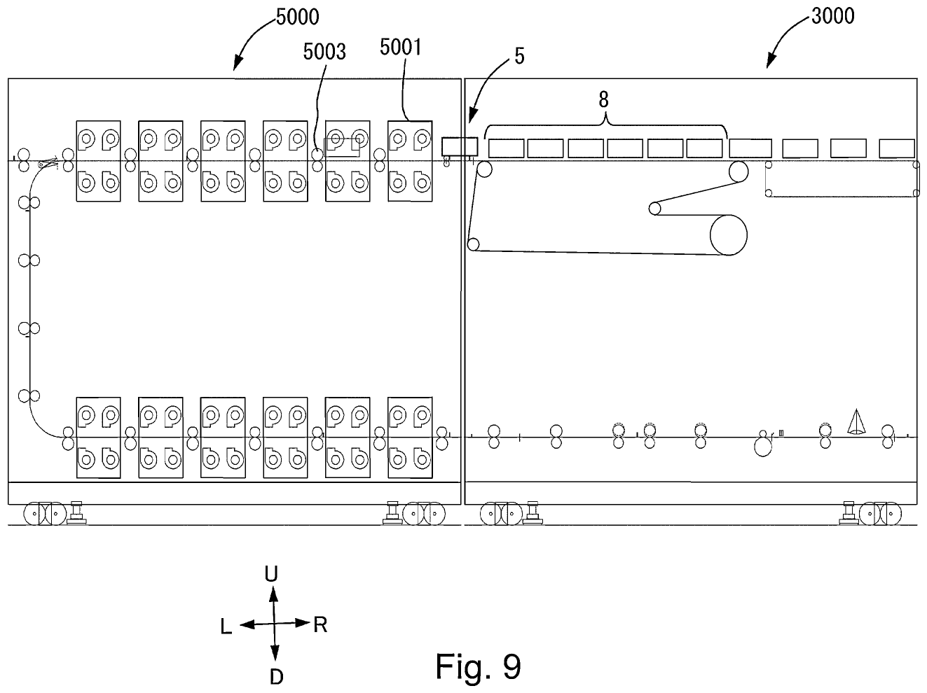

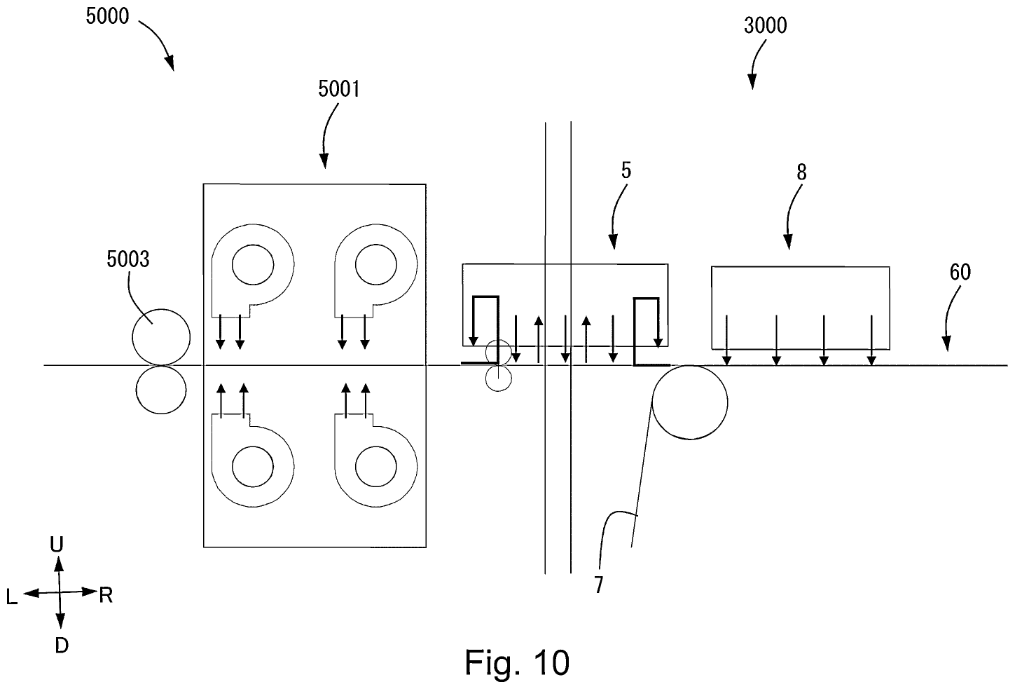

Next, a second embodiment of the present invention will be described in detail with reference to FIG. 9 and FIG. 10. In the embodiment, a configuration differs from that of the first embodiment in that the circulating air blowing unit 5 is disposed downstream of the warm air blowing unit 8 with respect to the sheet conveying direction. However, since other configurations are the same as in the first embodiment, the same reference numerals are used and detailed descriptions are omitted.

A view of an overall apparatus according to the embodiment is shown in FIG. 9. In the embodiment, the cooling module 5000 is connected downstream of the drying module 3000 with respect to the sheet conveying direction. This is intended for the inkjet recording system 100 which does not require a fixing module 4000 by limiting surface properties of the sheet S in which the inkjet recording system 100 supports (for example, only uncoated sheets are supported, etc.) for example.

The cooling module 5000 includes a conveying roller 5003 which conveys the sheet S. The conveying roller 5003 is rotated by a driving source such as an unshown motor. The conveying roller 5003 is one of examples of a second conveyance portion, and is disposed adjacent to the drying belt unit 60 with respect to the sheet conveying direction and conveys the sheet S in which an image is formed in the printing module 2000.

In the embodiment, it is intended for a case that the cooling module 5000 is disposed just after the drying module 3000. That is, in the embodiment, the cooling portion 5001 of the cooling module 5000 is disposed adjacent to and downstream of the warm air blowing unit 8 with respect to the sheet conveying direction, and is a cooling unit which cools the sheet S which is conveyed from the warm air blowing unit 8. In this case, the warm air from the drying module 3000 may diffuse to the cooling module 5000 through the conveyance passage, or the cold air from the cooling module 5000 may diffuse to the drying module 3000 through the conveyance passage. As a result, deterioration of drying function of the drying module 3000 or deterioration of the cooling function of the cooling module 5000 may be occurred.

Therefore, in the embodiment, as shown in FIG. 10, the circulating air blowing unit 5 is disposed between the warm air blowing unit 8 in the drying module 3000 and the cooling portion 5001 in the cooling module 5000. The circulating air blowing unit 5 is provided so that it is fixed to the drying module 3000, while protruding from a casing of the drying module 3000 toward a side of the cooling module 5000. The cooling module 5000 is connected to the drying module 3000 while the circulating air blowing unit 5 which protrudes from the drying module 3000 is inserted into a mounting hole which is formed in a casing of the cooling module 5000 and enters an inside of the cooling module 5000.

As described above, in the inkjet recording system 100 according to the embodiment, the circulating air blowing unit 5 is disposed between the warm air blowing unit 8 and the cooling portion 5001. This prevents the cold air from the cooling portion 5001 from affecting the sheet drying function by the warm air blowing unit 8 or the warm air from the drying module 3000 from affecting the sheet cooling function by the cooling portion 5001. As a result, it is possible to suppress diffusion of the warm air in the main assembly which is blown inside the main assembly of the inkjet recording system 100 while drying the sheet S by the warm air, so it is possible to suppress an occurrence of cockling, a deterioration of drying function, a deterioration of cooling function, etc.

### Third Embodiment

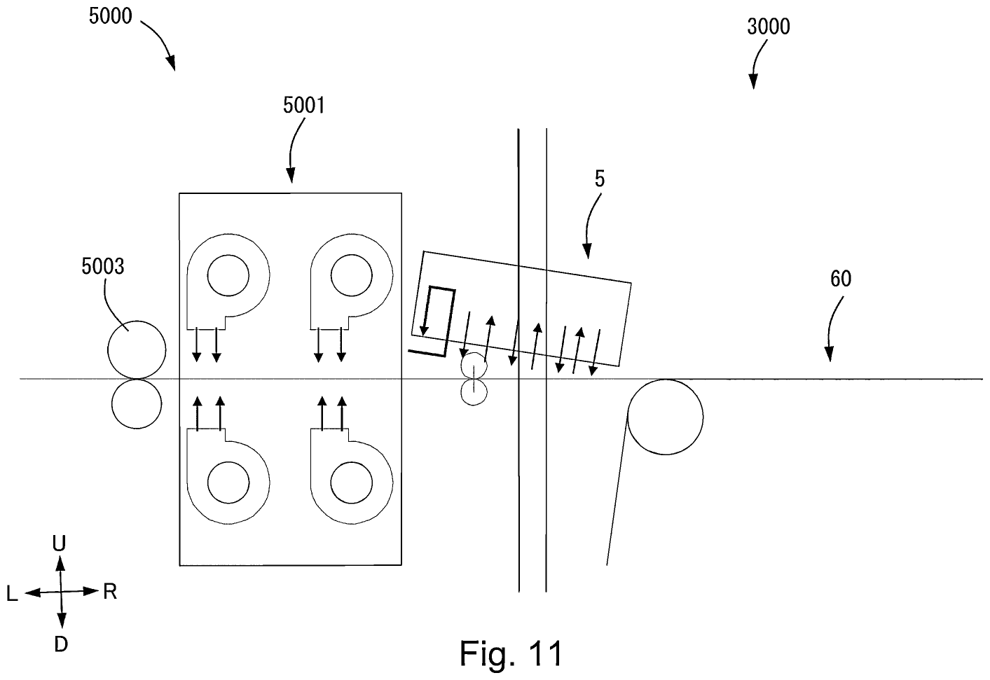

Next, the third embodiment of the present invention will be described in detail with reference to FIG. 11. In the embodiment, a configuration differs from that of the second embodiment in that drying of the sheet S is performed by the drying belt unit 60 instead of the warm air blowing unit 8. However, since other configurations are the same as in the second embodiment, the same reference numerals are used and detailed descriptions are omitted.

A configuration according to the embodiment is shown in FIG. 11. In the embodiment, drying of the sheet S is not performed by the warm air blowing unit 8, but by the drying belt unit 60 which is provided with a heater. In the embodiment, drying of the sheet S is performed by using only the drying belt unit 60 which is provided with the belt heater 9a (see FIG. 2) instead of the warm air blowing unit 8. Incidentally, the temperature of the drying belt 7 is from 70° C. to 100° C.

That is, in the embodiment, the drying belt 7 is one of examples of a conveying belt and conveys the sheet on which an image is formed in the printing module 2000. Further, the belt heater 9a is one of examples of a heating means and heats the drying belt 7. Further, the cooling portion 5001 is one of examples of an air blowing unit and blows air onto the sheet S which is conveyed by the conveying roller 5003. The circulating air blowing unit 5 is disposed adjacent to a side of the drying belt unit 60 (a side of the conveying portion) of the cooling portion 5001 with respect to the sheet conveying direction. The suction duct 37 of the circulating air blowing unit 5 sucks a part of the air which is blown from the cooling portion 5001.

In the embodiment, the circulating blowing unit 5 is disposed between the cooling portion 5001 and the drying belt unit 60. In this way, it is possible to reduce effect of the cold air from the cooling portion 5001 on drying function of the drying belt unit 60.

Further, in the embodiment, a direction of the air which comes from the circulating air blowing unit 5 is tilted toward a side of the cooling module 5000. That is, the circulating air blowing unit 5 is disposed in an inclined posture toward the side of the cooling portion 5001 (a side of the air blowing unit) with respect to the sheet conveying direction, the suction duct 37 sucks the air from the side of the cooling portion 5001, and the blowing nozzle 30 blows the air toward the side of the cooling portion 5001. By configuring like this, the effect of the cold air from the side of the cooling portion 5001 on the drying belt unit 60 is reduced. Incidentally, the direction of the air which comes from the circulating air blowing unit 5 is not limited to tilting toward the side of the cooling module 5000, but may be directed downward in the vertical direction as in the second embodiment.

### Fourth Embodiment

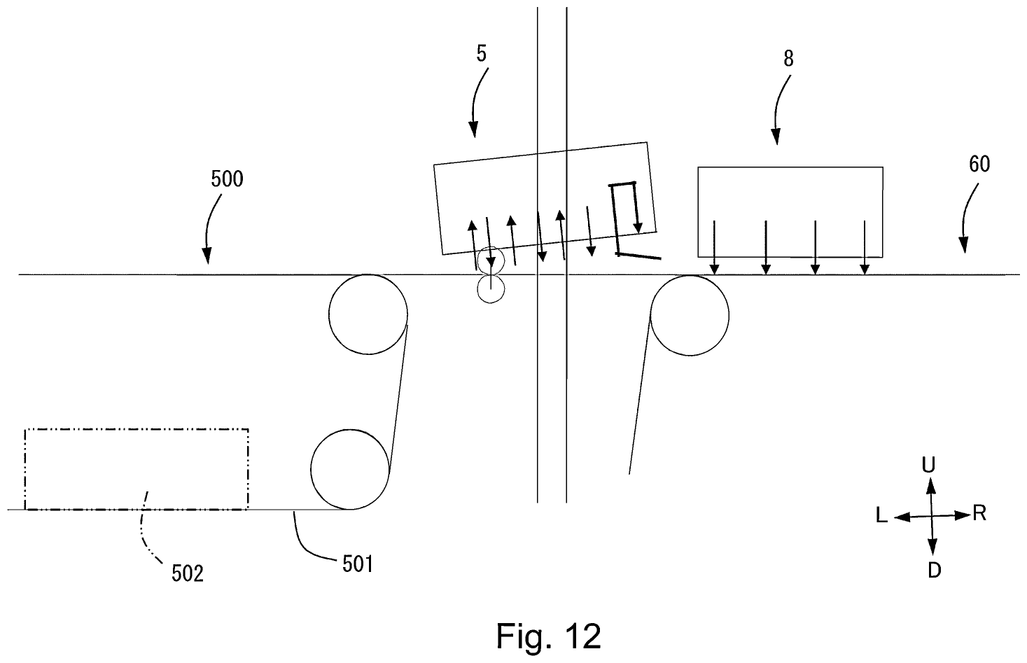

Next, the third embodiment of the present invention will be described in detail with reference to FIG. 12. In the embodiment, a configuration differs from that of the second embodiment in that cooling of the sheet S is performed by a cooling belt unit 500 instead of the cooling portion 5001. However, since other configurations are the same as in the second embodiment, the same reference numerals are used and detailed descriptions are omitted.

A configuration according to the embodiment is shown in FIG. 12. In the embodiment, cooling of the sheet S is not performed by the cooling portion 5001, but by the cooling belt unit 500, which lowers the temperature of the sheet S by contacting with a cooling belt 501. The cooling belt unit 500 is one of examples of the second conveyance portion, is disposed adjacent to and downstream of the drying belt unit 60 with respect to the sheet conveying direction, and includes the cooling belt 501 and a heat sink 502. The cooling belt 501 is one of examples of the conveying belt, and conveys the sheet S on which an image is formed in the printing module 2000. The heat sink 502 is one of examples of a cooling means and cools the cooling belt 501 by contacting an inner peripheral surface of the cooling belt 501 and radiating heat from the cooling belt 501. The heat sink 502 includes a number of fins which are not shown, and is air cooled when a fan which is not shown blows air toward the plurality of fins.

In the embodiment, the circulating air blowing unit 5 is disposed between the cooling belt unit 500 and the warm air blowing unit 8. The circulating air blowing unit 5 is disposed adjacent to a side of the cooling belt unit 500 of the warm air blowing unit 8 with respect to the sheet conveying direction. In this way, it is possible to reduce the effect of the warm air from the warm air blowing unit 8 on a cooling function of the cooling belt unit 500.

Further, in the embodiment, a direction of the air which comes from the circulating air blowing unit 5 is tilted toward a side of the warm air blowing unit. That is, the circulating air blowing unit 5 is disposed in an inclined posture toward the side of the warm air blowing unit 8 with respect to the sheet conveying direction, the suction duct 37 sucks the air from the side of the warm air blowing unit 8, and the blowing nozzle 30 blows the air toward the side of the warm air blowing unit 8. By configuring like this, the effect of the warm air blowing unit 8 on the cooling belt unit 500 is reduced. Incidentally, the direction of the air which comes from the circulating air blowing unit 5 is not limited to tilting toward the side of the warm air blowing unit 8, but may be directed downward in the vertical direction as in the second embodiment. According to the present invention, it is possible to suppress diffusion of the warm air in the main assembly which is blown inside the main assembly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2023-100818 filed on Jun. 20, 2023 and 2023-138904 filed on Aug. 29, 2023, which are hereby incorporated by reference herein in their entirety.

What is claimed is:

1. An image forming apparatus comprising:
a conveyance portion configured to convey a sheet on which an image is formed by an image forming portion which forms the image on the sheet by ejecting ink;
a first blowing unit configured to blow air onto the sheet conveyed by the conveyance portion;
a second blowing unit including a heating means and configured to blow air heated by the heating means onto the sheet conveyed by the conveyance portion; and
a third blowing unit disposed between the first blowing unit and the second blowing unit with respect to a sheet conveyance direction, and including a suction portion configured to suck a part of the air of the conveyance portion, a duct portion through which the air sucked by the suction portion flows and a blowing portion configured to blow the air flowing through the duct portion onto the sheet.

2. An image forming apparatus according to claim 1, wherein the conveyance portion includes a first conveyance portion and a second conveyance portion disposed adjacent to the first conveyance portion with respect to the sheet conveyance direction and configured to convey the sheet on which the image is formed by the image forming portion,
wherein the first blowing unit blows the air heated by the heating means onto the sheet conveyed by the first conveyance portion,
wherein the second blowing unit blows the air onto the sheet conveyed by the second conveyance portion, and
wherein the third blowing unit blows the air flowing through the duct portion onto the sheet conveyed between the first conveyance portion and the second conveyance portion.

3. An image forming apparatus according to claim 2, wherein the third blowing unit is disposed above the first conveyance portion and the second conveyance portion in a vertical direction, the suction portion sucks the air upward in the vertical direction and the blowing portion blows the air downward in the vertical direction.

4. An image forming apparatus according to claim 1, wherein the first blowing unit includes a suction duct configured to suck the air from an outside of the image forming apparatus and is a blowing unit configured to blow the air sucked from the suction duct onto the sheet conveyed by the conveyance portion, and
wherein the third blowing unit is disposed downstream of and adjacent to the blowing unit with respect to the sheet conveyance direction.

5. An image forming apparatus according to claim 1, wherein the second blowing unit is a drying unit configured to dry the sheet on which the image is formed, and
wherein the second blowing unit is disposed downstream of and adjacent to the third blowing unit with respect to the sheet conveyance direction.

6. An image forming apparatus according to claim 1, wherein a temperature of the air blown onto the sheet by the blowing unit is lower than a temperature of the air blown by the first blowing unit.

7. An image forming apparatus according to claim 2, further comprising a switching portion disposed downward the third blowing unit in a vertical direction and configured to switch between the first conveyance portion and the second conveyance portion.

8. An image forming apparatus according to claim 1, wherein the first blowing unit is provided with a sucking portion configured to suck a part of the air of the conveyance portion and a discharging portion configured to discharge the air shucked by the sucking portion to an outside of the image forming apparatus.
